(19) United States
(12) Patent Application Publication
(10) Pub. No.: US 2006/0249590 A1
(43) Pub. Date: Nov. 9, 2006

(54) Debris tolerant temperature responsive valve

(76) Inventor: Robert D. Dulin, Kingsbury, TX (US)

Correspondence Address: Patent Office of David P. LeCroy, Post Office Box 631, Manville, NJ, 08835-0631, US

(21) Appl. No.: 11/224,421

(22) Filed: Sep. 12, 2005

Related U.S. Application Data
(60) Provisional application No. 60/678,159, filed on May 6, 2005.

(51) Int. Cl. G05D 23/02; G05D 23/08

(52) U.S. Cl. 236/93 R

(57) ABSTRACT

A temperature sensitive valve is disclosed herein. The valve has a piston, thermal sensor containing a thermally sensitive material, and biasing element. The thermal sensor is in contact with the surrounding fluid so that thermal material contracts in ambient temperatures, allowing the valve to open. With the valve open, the surrounding fluid is replaced by warmer fluid, heating the thermal material causing it to expand and the thermal sensor close off flow through the valve.

### CROSS REFERENCE TO RELATED APPLICATIONS

This application claims the benefit of U.S. Provisional Application No. 60/678 159, filed May 6, 2005.

### BACKGROUND OF THE INVENTION

1. Field of the Invention

The present invention relates to valves. More specifically, the present invention relates to a temperature actuated valve that automatically opens in response to a predetermined temperature, thereby enabling fluids to pass through the valve, and that automatically closes when the temperature rises back above that predetermined temperature.

2. Background Information

Water is often required to be held in tanks such as waterers for livestock in all kinds of weather conditions. Changes in the environment, such as freezing or below freezing temperatures often lasting for days at a time, can cause this water supply to become inaccessible to livestock as a drinking source when needed due to ice forming at the surface of the water in the waterer.

Waterers are supplied with the goal of providing a continuous and open source of water for livestock. However, during winter these waterers are subject to freezing, removing that source of water. The frozen water in the waterer requires intervention by the rancher to heat the waterer and/or remove the surface ice so that his livestock have an open water source.

Likewise, during summer the water in the waterer can warm up considerably. It has been learned that dairy cows reduce their milk production if the temperature of their drinking water is around or greater than about ° C. (90° F.).

As a solution to this concern of providing water in ambient conditions, a multitude of alternatives have been proposed for maintaining a continuously available drinking water source. These include allowing water to continuously flow through the waterer, which can be wasteful in the usage of that water. Another anti-freezing solution requires the use of electric immersion heaters. However, this solution can require undue energy usage. Accordingly, there is a need for a device that serves in preventing the freezing or heating of such water sources. Preferably, the device does so automatically (i.e., when freezing conditions are encountered) without the need for human intervention.

Further, water sources such as livestock waterers often contain debris such as hay, grass, grain, algae and soil. Therefore, there is a need for a device that is both useful in the prevention of the freezing and/or heating of a water source and that also is not disabled by debris that may be found in that source.

### SUMMARY OF THE INVENTION

The present invention disclosed herein is a temperature actuated valve that alleviates the drawbacks described above with respect to providing a continual source of water. The valve of the present invention is easily installed in a water source such as a livestock waterer. It allows the control of the flow of the liquid in the trough to be unattended, regardless of how low or high the surrounding air temperature may be. The valve further allows such unattended control, even though the presence of debris risks blocking flow there through.

The valve of the present invention is temperature sensitive and has a valve piston in combination with a thermal element for regulating flow through the valve. The valve further has a seat wherein the seat and the thermal element are arranged so that no springs or braces block the fluid flow path. In another aspect, the seat and thermal element are arranged so as to shear any debris that may have traversed the sealing edge. Further, the thermal element is arranged so as to quickly sense and respond to the temperature of the fluid surrounding it. In another aspect the thermal element is movable such that the fluid flow path can be opened to allow passage of potential debris there through.

As designed, the valve of the present invention is easily and conveniently installed. Its simple design allows it to be inexpensively manufactured. It may be manufactured in a wide range of sizes. By proper selection of materials, the present invention may be used for controlling a wide variety of flow at various temperatures.

Accordingly, the present invention provides for a temperature sensitive valve having valve housing. The housing includes a proximate end having a lower housing chamber and a distal end having an upper housing chamber. The housing also has one or more ports for allowing fluid flow there through.

The valve further includes a thermal sensor disposed within the lower and upper chambers of the valve housing. The sensor has a proximate cap, distal cap and thermal chamber for placement of a thermally sensitive material therein.

In conjunction with the thermal sensor is a valve piston slidably disposed at a distal end of the thermal sensor and in contact with a housing piston seat. The valve also includes a biasing element disposed within the upper housing chamber and in contact with a sensor distal flange and an upper chamber seat. The biasing element displaces the thermal sensor distally and axially along the valve housing chambers.

In operation, the temperature of fluid around the thermal sensor is detected by the thermally sensitive material, causing the thermal sensor to move to a valve closed position wherein the biasing element is compressed when the fluid temperature is above an actuating temperature or temperature range.

In another aspect, the temperature of fluid around the thermal sensor is detected by the thermally sensitive material, causing the thermal sensor to move to a valve open position wherein the biasing element is extended when the fluid temperature is above an actuating temperature or temperature range.

In a further embodiment, the valve includes a filter for preventing debris from passing through the inlet ports of the valve.

In another embodiment the valve thermal sensor is designed such that it can break any debris that blocks an outlet port of the valve.

The flow path of the valve is designed such that it contains no springs, braces or protrusions that may trap or snag debris and cause its accumulation in the path of flow.

In one embodiment the valve has the ability to open much farther than necessary for the flow that is required, so that large debris may pass and be discharged.

The present invention is also directed towards a method of controlling flow through a valve in freezing conditions. The valve includes a valve housing having an anterior end and a posterior end and an internal wall for housing a valve piston, biasing element and thermal sensor. The thermal sensor contains thermally sensitive material that is able to expand and contract according to the surrounding fluid temperature. The piston is sealably engaged with the sensor.

The method includes contracting the thermal material as the surrounding fluid temperature approaches the freezing temperature of water. With this contraction, the thermal sensor moves towards the anterior end of the housing, breaking the thermal sensor's sealable engagement with the posterior end of the housing, thereby automatically creating at least one flow passage through the valve. This flow passage through the valve automatically closes as the surrounding fluid temperature rises above a predetermined temperature.

In another aspect the method includes contracting the thermal material as the surrounding fluid temperature approaches an elevated water temperature, for example, approximately ° C. (90° F.). The flow passage through the valve created with the contraction of the thermal material automatically closes as the surrounding fluid temperature falls below a predetermined temperature. Accordingly, the method also includes the valve with a decrease in temperature.

In even a further aspect, the method includes reversing flow through the valve from at least one outlet port to at least one inlet port. This can occur, for example, when the ‘outlet’ port of the valve is connected to a pump from a water well to, for example, to an irrigation system. In this manner, the valve closes during freezing temperatures, preventing water from the well from freezing in the water lines of the irrigation system.

Regulation of the opening and closing of the flow passage at different temperature ranges can be set simply by varying the thermal material within the sensor.

In a further embodiment the method further includes filtering debris from entering through the inlet ports of the valve with a filter. In even a further embodiment the method further includes removing debris blocking the outlet port by movement of the thermal sensor. In one aspect, the design of the thermal sensor is such that it is able to shear any debris blocking the outlet port.

The general beneficial effects described above apply generally to each of the exemplary descriptions and characterizations of the devices and mechanisms disclosed herein. The specific structures through which these benefits are delivered will be described in detail herein below.

### BRIEF DESCRIPTION OF THE DRAWINGS

FIG. 1 is a side perspective view of a temperature actuated valve according to the present invention.

FIG. 2 is an exploded perspective view of a temperature actuated valve according to the present invention.

FIG. 3 is an exploded perspective view of a thermal sensor for use in a temperature actuated valve according to the present invention.

FIG. 4 is a perspective view of piston rod in conjunction with a distal cap of the thermal sensor of FIG. 3.

FIG. 5 is a perspective view of the lower valve housing illustrating the valve inlet ports according to the present invention.

FIG. 6a is a plan view of bottom of the lower valve housing illustrating a valve outlet port embodying the present invention.

FIG. 6b is a plan view of the bottom of the upper valve housing illustrating a piston seat embodying the present invention.

FIG. 7 is a cross sectional view of a temperature actuated valve according to the present invention.

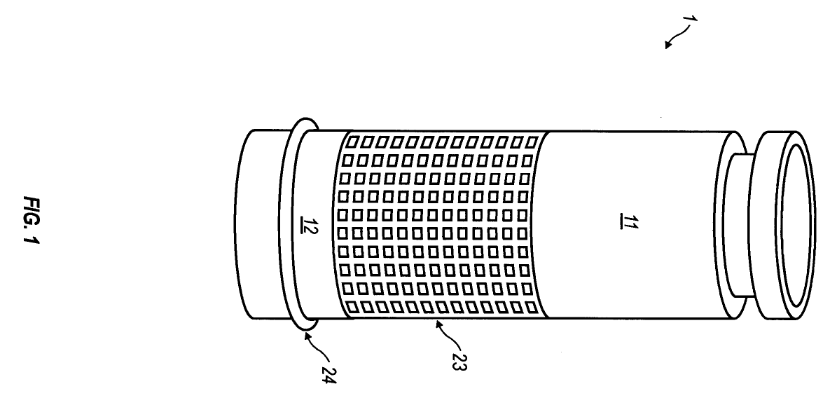

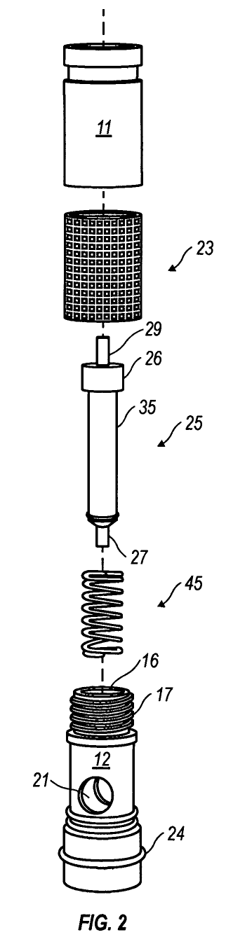

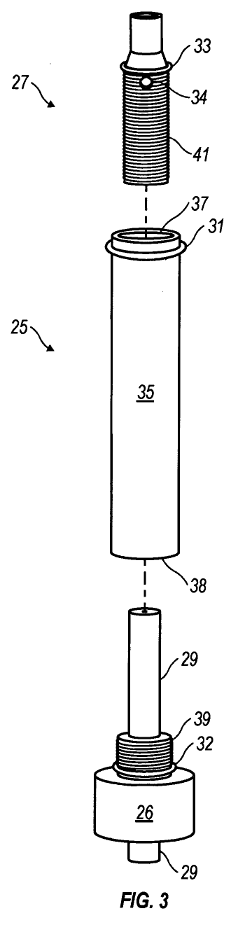

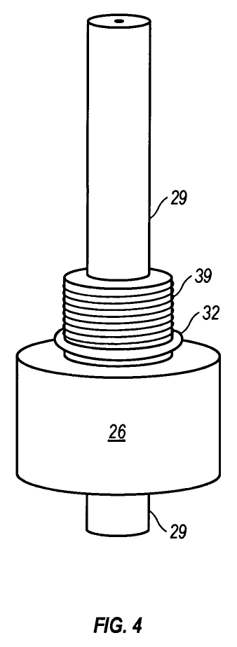

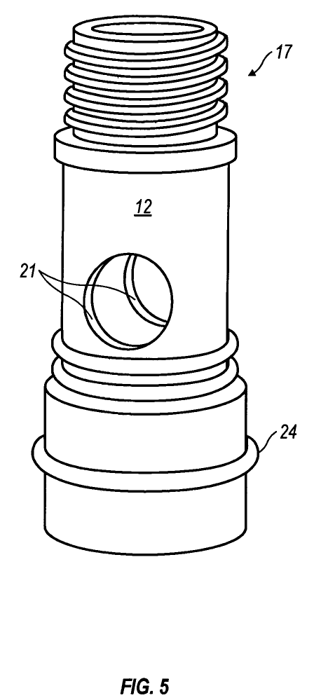

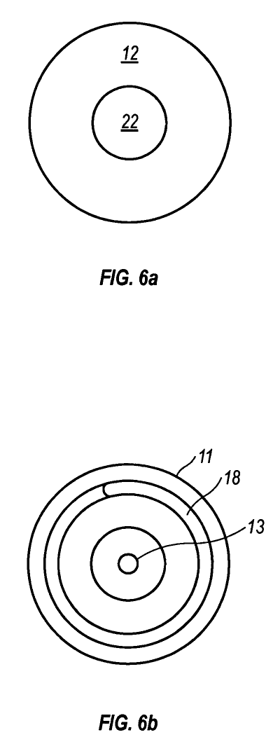

### DETAILED DESCRIPTION OF THE INVENTION:

As required, detailed embodiments of the present invention are disclosed herein. However, it is to be understood that the disclosed embodiments are merely exemplary of the invention that may be embodied in various and alternative forms. The figures are not necessarily to scale, and some features may be exaggerated or minimized to show details of particular components. Therefore, specific structural and functional details disclosed herein are not to be interpreted as limiting, but merely as a basis for the claims and as a representative basis for teaching one skilled in the art to variously employ the present invention. For example, although described as a singular product to be added to a waterer, it should be understood that the valve may be built into the waterer if so desired. Further, that the while the present design is illustrated for operation in livestock waterers, it should be understood that the invention is not limited to use in only those applications. Also, it should be understood that the while the present design is optimized for operation in livestock waterers, this does not limit the invention to use only in such applications.

Referring to the drawings, the temperature actuated valve of the present invention is indicated generally at 1. The valve or valve housing 10 has a proximate end 11 and a distal end 12. The valve 1 is comprised of a hollow cylindrical housing 10 having an upper chamber 15 and lower chamber 16 therein, with the lower chamber 16 of smaller diameter than the upper chamber 15, effectively forming an interior lip 14 separating the two chambers 15, 16. The interior portion of the distal end 12 of the housing 10 is conically disposed about the center or has therein a central groove 19 within the upper chamber 15. The valve housing 10 may have one or more ports 21, 22 for fluid flow there through. The ports and their function will be described more fully hereinafter.

In one embodiment, the upper housing 12 is separable from the lower housing 11. In this respect, each section is securably engagable (e.g., threadably, snap-on, etc.). As illustrated, the lower housing 11 is externally threaded 17 and the upper housing is internally threaded 18 whereby the two sections are able to be joined together. While the drawings illustrate externally threaded 17 lower housing 11 and internally threaded 18 upper housing 12, it should be understood that either housing may be internally or externally threaded or otherwise securably engagable. As illustrated, the lower housing 11 includes a gasket for sealing off flow between the valve 1 and the tank outlet that it is placed in. However, in another embodiment, this housing can be threaded for engaging with a pressurized water line, for example, a large irrigation line.

Disposed within the upper 15 and lower chamber 16 of the valve housing 10 is a thermal sensor 25. The thermal element 25 has a distal or posterior end 26 and a proximate or anterior end 27. The distal end 26 is smaller in external diameter than the upper chamber 15 but greater in diameter than both the sensor proximate end 27 and lower chamber 16. The sensor proximate end 27 is of smaller diameter than the lower chamber 16, with at least a portion of the sensor proximate end 27 of only slightly smaller diameter 35.

As illustrated, the sensor 25 has a central cylindrical portion 28, an anterior cap 26 and a posterior cap 27. The central portion 28 is hollow and internally threaded at each end for receiving the anterior 26 and posterior cap 27. Disposed about the central portion 28 is at least one groove 36 for receiving a gasket 31 there about the sensor 25. The sensor gasket 31, when placed on the sensor central portion 28, is sealingly engagable with the interior wall of the lower chamber 16.

As previously indicated, the distal cap 26 is of a larger diameter than the lower chamber 16. Extending proximately from the distal cap 26 is a threaded portion 39 for engaging with the central sensor 28. This distal cap 26 has a centrally located port or passage 40 there through. Disposed within this passage 40 is a piston rod or shaft 29 extending beyond both ends of the distal cap 26 so that at least a portion of the rod 29 extends into the central portion 35 and the upper chamber 15. The portion of the rod 29 in the upper chamber 15 extends such that it can be seated in the central groove 19. Between the passage 40 and the rod 39 are one or more gaskets for sealably and securably placing the rod 29 within the passage 40.

The proximate cap 27 has a threaded portion 41 for engaging with the central sensor 35. In one embodiment, the threaded portion 41 is hollow forming an open-ended chamber 42. Disposed on this threaded portion 41 is at least one port 34. The port 34 and chamber 42 and their function will be described more fully hereinafter.

Both the distal cap 26 and proximate cap 27 may optionally have one or more gaskets 32, 33 for sealably engaging with the central sensor cylinder 28. In one aspect, the gaskets 32, 33 are disposed between the threaded portions 39, 41 and each cap 26, 27. In order to improve the seal between these elements, in one embodiment the central sensor cylinder 28 is provided in with an anterior lip 37 and a posterior lip 38 for receiving each gaskets 32, 33.

When in use, the distal cap 26 is secured to the central sensor cylinder 28 and the sensor 25 is filled with a thermal material 44 that expands and contracts based upon variations in temperature. In one embodiment, with the distal cap 26 secured, the proximate fill cap 27 is at least partially engaged onto the central sensor cylinder 28. The material 44 is then injected into the chamber of the central sensor 28 through a fill cap port 34 and fill cap chamber or passage 42. By being internally disposed in the thermal sensor 25 and thereby in contact with the valve piston 29, the thermal material 44 is able to press against the piston 29, moving the thermal sensor 25 along the chamber 15, 16 of the housing 10 as temperature variations occur within a predetermined temperature range.

An helical coil spring or biasing element 45 is disposed at one end of the upper housing chamber 15 substantially concentrically about the central sensor 28 with one end abutting one side of the distal cap 26 and the other end seated against a distal housing lip 14 within the upper chamber 15. When relaxed and extended, the biasing element 45 extends at least a portion of the length of the central sensor 35, thereby biasing the thermal element 25 towards the posterior end 12 of the housing 10.

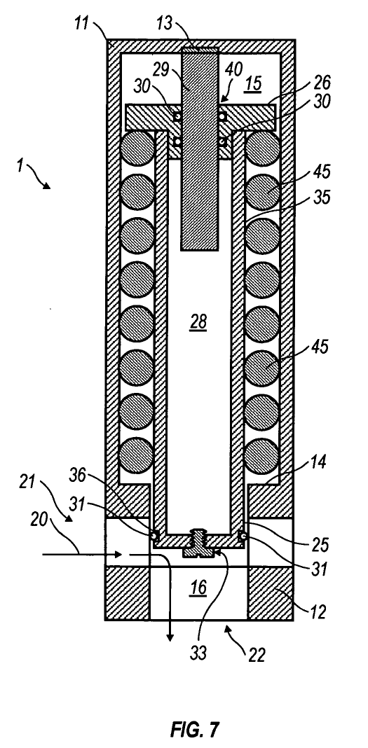

Referring again to the Figures, the operation of the valve is as follows: With temperatures at or above a predetermined activation temperature, the thermal material 44 is expanded, pushing against the piston rod 29 so that the rod 29 extends outwardly from the sensor 25. The end of the rod exterior to the sensor 25 is centered against the interior wall of the upper housing chamber 11 in a piston seat groove 13. As the thermal material 44 expands in the chamber 28, the pressure from its expansion is relieved by pushing the rod outwardly from the sensor 25. As one end of the rod 29 is position in the groove 13 against the interior wall of the upper housing 11, the thermal element 25 slidably biased towards the proximate end 11 of the housing 10. Obviously, the rod 29 should be of such length as to extend the sensor 25 so that the valve 1 is fully closed, yet not so short as to be pushed out of the sensor 25 by the expanding thermal material 44. When the valve 1 is in its closed position, the proximate cap 27 and at least a portion of the central chamber 28 of the sensor 25 is seated against a portion of the interior wall of the lower housing chamber 12, compressing the biasing element 45. With the sensor 25 transferred towards the proximate end 12 of the housing 10, the central sensor gasket 31 engages with the interior wall of the lower housing chamber 16 below the inlet ports 21, blocking fluid from exiting the dump port 22, as illustrated in FIG. 7. Fluid is still able to flow through inlet ports 21 around the thermal sensor 25, transferring its temperature to the thermal material 44 within the central thermal cylinder 28.

As the temperature reaches a predetermined activation temperature (e.g., the freezing temperature of water, or the freezing temperature of the thermal material), the thermal material 44 begins to contract, thereby allowing the pressure of the compressed biasing element 45 to push against the distal cap 26, moving the thermal element 25 towards the distal end 11 of the housing 10, causing the piston 29 to move within the thermal sensor 25. As the thermal sensor 25 moves up and the piston 29 enters the sensor 25, the thermal element gasket 31 breaks contact from the lower housing chamber 16 below the inlet ports 21, allowing fluid to flow through the outlet port 22. At least a portion of the sensor 25 remains in contact with the fluid. The fluid flows out through the outlet port 22 until the fluid surrounding the sensor 25 is replaced by warmer fluid. This heating of the sensor 25 by this warmer fluid is transferred through the sensor 25 to the thermal material 44, causing the material 44 to expand and the sensor 25 to close off fluid flow through the outlet port 22.

In another aspect, the present valve 1 is designed such that any debris that may stop flow through the outlet port 22 is prevented. This is accomplished in at least four manners. Firstly, the present valve 1 provides for an optional, replaceable housing filter or screen 23 that permits fluid to enter through the inlet ports 21 while blocking debris. Secondly, the sensor 25 is designed such that it is able to shear or break any debris (e.g., grass, straw, etc.) That may pass through the filter 23 and block the outlet port 22. Thirdly, the valve is designed so that it is able to open much farther than is necessary for the flow that is required, so that debris that may be blocking the inlet port(s) 21 may pass thru to the outlet port 22. Fourthly, the path of flow 20 is free of any springs, braces or other impediments that may trap or snag debris. In the embodiment illustrated in the Figures, this can be accomplished by the design of the proximate end 27 of the sensor 25. This conical shape allows the sensor 25 to push debris through the outlet port 22 as the valve 1 moves to its closed state. This conical shape also extends the surface area of the sensor, thereby enhancing the thermal exchange between the sensor and the discharging fluid. As the sensor gasket 31 contacts the interior wall of the lower housing 12, any remaining debris that has not be forced through the outlet port 22 is sheared off between the lower housing 12 and the sensor 25.

Although the present invention has been described and illustrated in detail, it is to be clearly understood that the same is by way of illustration and example only, and is not to be taken as a limitation. The spirit and scope of the present invention are to be limited only by the terms of any claims presented hereafter.

Industrial Applicability. The present invention finds applicability in the valve industry, and more specifically in automatic flow valves. Of particular importance is the invention's ability to provide a reliable source of water in temperature sensitive and debris contaminated conditions.

What is claimed is:

1. A temperature sensitive valve comprising:
a valve housing having a proximate end having a lower housing chamber and a distal end having an upper housing chamber, the housing having one or more ports for allowing fluid flow there through;
a thermal sensor disposed within the lower and upper chambers of the valve housing, the sensor having a proximate cap, distal cap and thermal chamber for placement of a thermally sensitive material therein;
a valve piston slidably disposed at a distal end of the thermal sensor and in contact with a housing piston seat; and
a biasing element disposed within the upper housing chamber and in contact with a sensor distal flange and an upper chamber seat;
wherein the biasing element displaces the thermal sensor distally and axially along the valve housing chambers; and
wherein the temperature of fluid around the thermal sensor is detected by the thermally sensitive material, causing the thermal sensor to move to a valve closed position wherein the biasing element is compressed when the fluid temperature is above an actuating temperature or temperature range.

2. The valve of claim 1 further comprising a filter for preventing debris from passing through the inlet ports of the valve.

3. The valve of claim 1 wherein the thermal sensor is designed such that it can break any debris that blocks an outlet port of the valve.

4. The valve of claim 1 wherein the path of flow contains no springs, braces or protrusions that may trap or snag debris and cause its accumulation in the path of flow.

5. The valve of claim 1 wherein the valve has the ability to open much farther than necessary for the flow that is required, so that large debris may pass and be discharged.

6. A method of controlling flow through a valve in freezing conditions, said valve comprising a valve housing having an anterior end and a posterior end and an internal wall for housing a valve piston, biasing element and thermal sensor, wherein the thermal sensor contains thermally sensitive material that is able to expand and contract according to the surrounding fluid temperature, and wherein said piston is sealably engaged with said sensor, said method comprising the steps of:
contracting said thermal material as the surrounding fluid temperature approaches the freezing temperature of water;
moving the thermal sensor towards said anterior end of said housing; and
breaking the thermal sensor's sealable engagement with the posterior end of the housing, thereby automatically creating at least one flow passage through the valve,
wherein said flow passage through the valve automatically closes as the surrounding fluid temperature rises above a predetermined temperature.

7. The method of claim 6 further comprising the step of filtering debris from entering through the inlet ports of the valve with a filter.

8. The method of claim 6 further comprising the step of removing debris blocking the outlet port by movement of the thermal sensor.

9. The method of claim 6 further comprising the step of closing the valve with a decrease in temperature.

10. The method of claim 6 further comprising the step of reversing flow through the valve from at least one outlet port to at least one inlet port.
